(19) United States
(12) Patent Application Publication
(10) Pub. No.: US 2006/0109690 A1
(43) Pub. Date: May 25, 2006

(54) Buckling structure of christmas lamp

(76) Inventor: Wen Pin Chuang, Hsin Chu City (TW)

Correspondence Address: WEN PIN CHUANG, 235 Chung-Ho, Box 8-24, Taipei, TW

(21) Appl. No.: 10/994,932

(22) Filed: Nov. 23, 2004

(51) Int. Cl. H01R 33/00

(52) U.S. Cl. 362/654; 362/806

(57) ABSTRACT

A buckling structure of a Christmas lamp comprises a bulb; a base; one lateral side of the base being extended with a buckling plate; the buckling plate having a bendable concave portion; a distal end of the buckling plate being installed a hook; a bulb seat; the bulb being inserted into the bulb seat; one lateral side of the bulb seat having a buckling ring for receiving the buckling plate. In assembly, when the bulb seat is combined with the base slowly, the hook of the buckling plate is inserted into the buckling ring. Alternatively, the buckling plate can be installed to the bulb seat and the buckling ring is installed to the base.

### FIELD OF THE INVENTION

The present invention is related to Christmas lamps, and particularly to a buckling structure of a Christmas lamp, wherein a buckling plate and a buckling ring are installed to a bulb seat and a base so that the bulb seat and the base are combinable by using the buckling plate and the buckling ring. In the present invention, the buckling plate and buckling ring are attached and detached manually with a simple operation.

### BACKGROUND OF THE INVENTION

Referring to FIG. 1, a prior art Christmas lamp 1 is illustrated. The Christmas lamp 1 is formed by a bulb 11, a bulb seat 12 and a base 13. A bottom of the Christmas lamp 1 is connected to a power wire 14. The bulb 11 is firstly inserted into the bulb seat 12. Then the bulb seat 12 is inserted into the base 13 so as to complete the assembly of the bulb. Conventionally, since no ideal buckling structure for combining the bulb seat 12 with the base 13, the two are assembled by force (referring to FIG. 2). Thereby they are easy to separate from one another due to collision or vibration in transfer process. As a result, the Christmas lamp can not light up.

In one improvement, a coupler is used to combine the seat with the base. However the couple also easily falls down from the lamp. Thereby in mold injection process, the coupler easily falls out from the mold so as to induce inconvenience in the manufacturing process.

### SUMMARY OF THE INVENTION

Accordingly, the object of the present invention is to provide a buckling structure of a Christmas lamp, wherein a buckling plate and a buckling ring are installed to a bulb seat and a base so that the bulb seat and the base are combinable by using the buckling plate and the buckling ring. In the present invention, the buckling plate and buckling ring are attached and detached manually with a simple operation.

To achieve above object, the present invention provides a buckling structure of a Christmas lamp which comprises a bulb; a base; one lateral side of the base being extended with a buckling plate; the buckling plate having a bendable concave portion; a distal end of the buckling plate being installed a hook; a bulb seat; the bulb being inserted into the bulb seat; one lateral side of the bulb seat having a buckling ring for receiving the buckling plate; wherein in assembly, when the bulb seat is combined with the base slowly, the hook of the buckling plate is inserted into the buckling ring. Alternatively, the buckling plate can be installed to the bulb seat and the buckling ring is installed to the base.

The various objects and advantages of the present invention will be more readily understood from the following detailed description when read in conjunction with the appended drawing.

### BRIEF DESCRIPTION OF THE DRAWINGS

FIG. 1 shows a perspective view of a prior art.

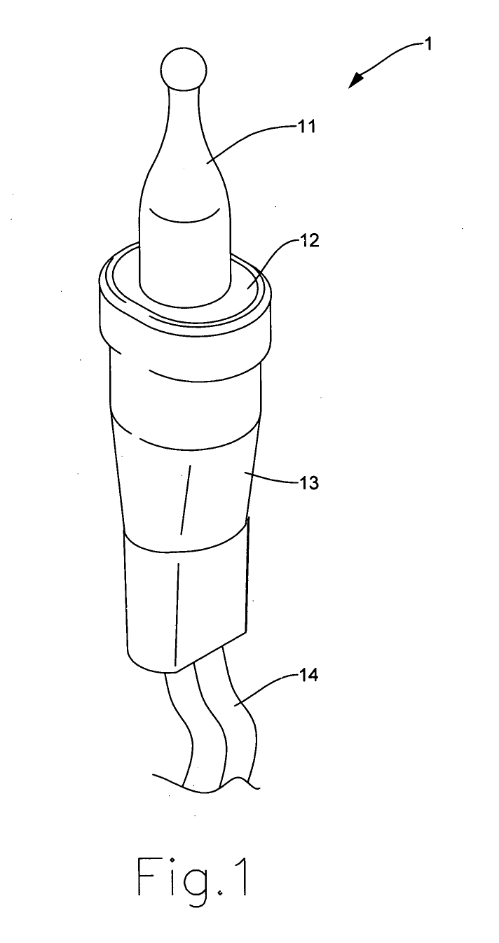

FIG. 2 is a schematic cross view of a prior art structure.

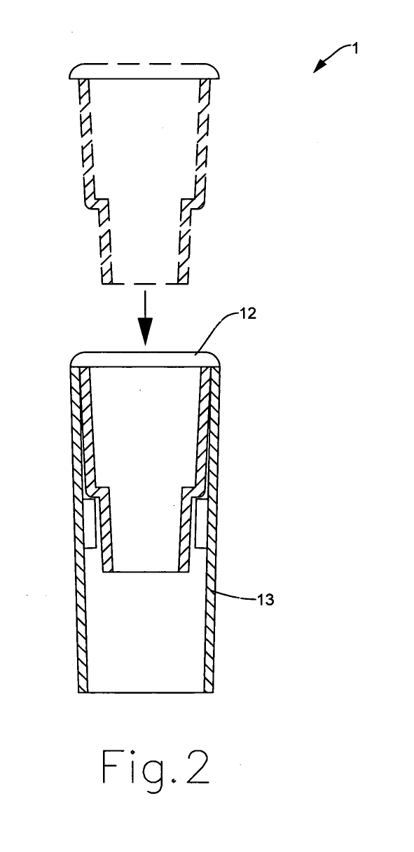

FIG. 3 is a perspective view of the present invention.

FIG. 4 is an exploded perspective view of the present invention.

FIG. 5 is a schematic view showing the operation of the present invention.

FIG. 6 is a partial enlarged cross sectional view of the present invention.

FIG. 7 is a partial enlarged schematic view of another embodiment of the present invention.

FIG. 8 is an exploded perspective view of the prior art, where a single bulb Christmas lamp 1 is used as an example.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

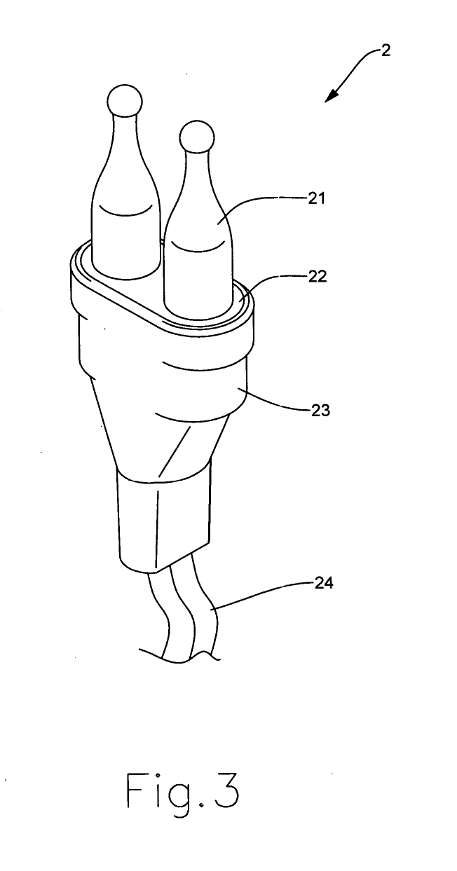

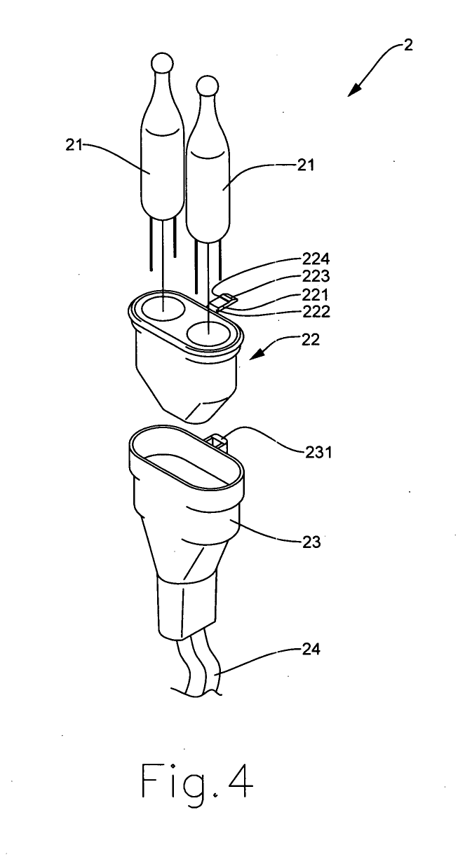

Referring to FIGS. 3 and 4, the buckling structure of a Christmas lamp of the present invention is illustrated The Christmas lamp 2 includes a bulb 21, a bulb seat 22 and a base 23. A bottom of the Christmas lamp 2 is connected to a power wire 24.

The bulb 21 is inserted into the bulb seat 22. One lateral side of the bulb seat 22 is extended with a buckling plate 221. The buckling plate 221 has a bendable concave portion 222. A distal end of the buckling plate 221 is installed with a guide inclined surface 223 and a hook 224.

One lateral side of the base 23 has a buckling ring 231 for receiving the buckling plate 221.

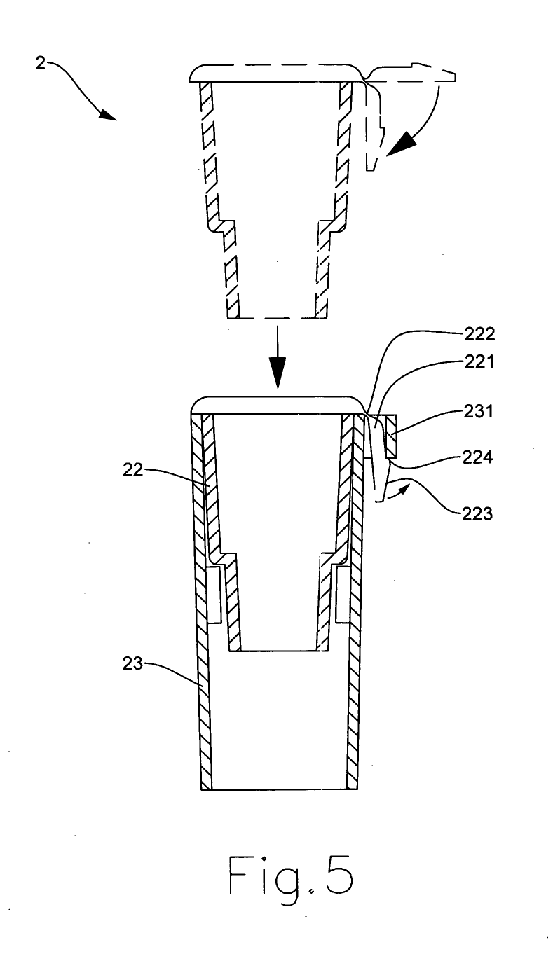

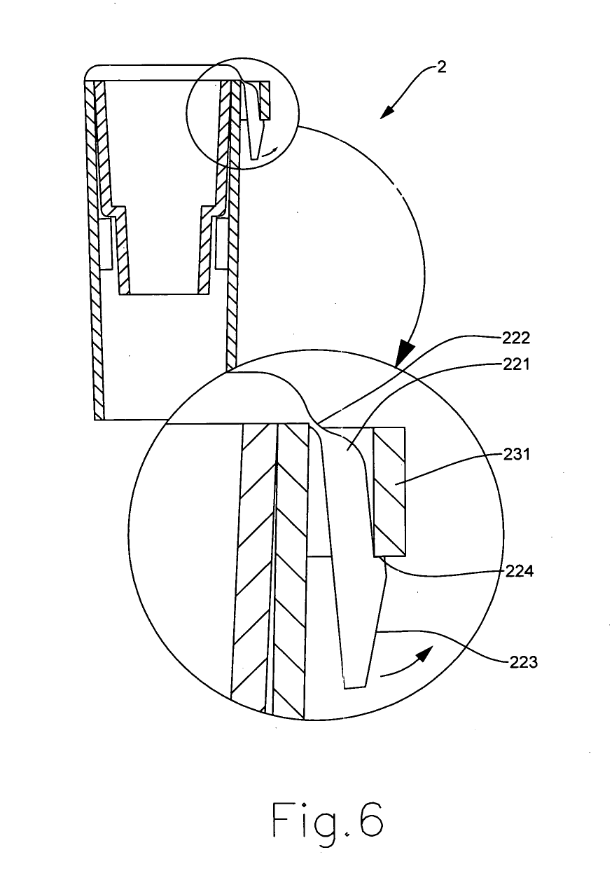

By above structure, when it is desired to combine the bulb seat 22 with the base 23, as shown in FIG. 5, the bulb seat 22 is inserted into the base 23 slowly. Meanwhile, the buckling plate 221 bends downwards. Next, the guide inclined surface 223 of the buckling plate 221 is inserted into the buckling ring 231. Finally, when the bulb seat 22 is wholly combined to the base 23, the buckling plate: 221 will have an elastic force so that the hook 224 may be buckled to the buckling ring 231 (referring to FIG. 6). Then, the bulb seat 22 is firmly secured to the base 23, even in transfer or as it is collided.

When the bulb seat 22 is combined to the base 23, if it is desired to take out the bulb seat 22 for updating or repairing, it is only necessary to press the buckling plate 221 inwards, so that the hook 224 is separated from the buckling ring 231. Thereby the bulb seat 22 can be taken out from the base 23 easily. The operation is convenient.

In the present invention, the base 23 may be installed with a buckling plate and the bulb seat 22 may be installed with a buckling ring for receiving the buckling plate of the base 23.

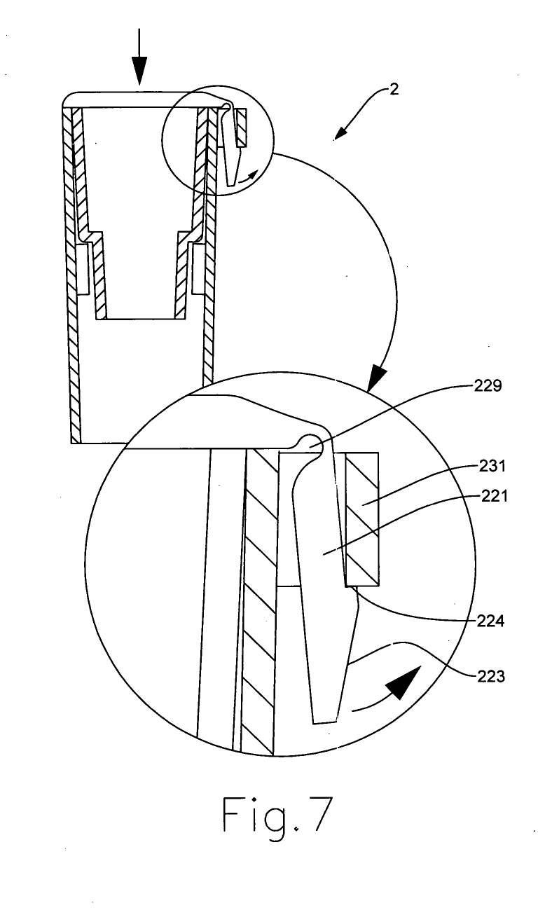

Other than at a top of the buckling plate 221, in another embodiment of the present invention illustrated in FIG. 7, the position of the concave portion 222 is at one end of the buckling plate 221.

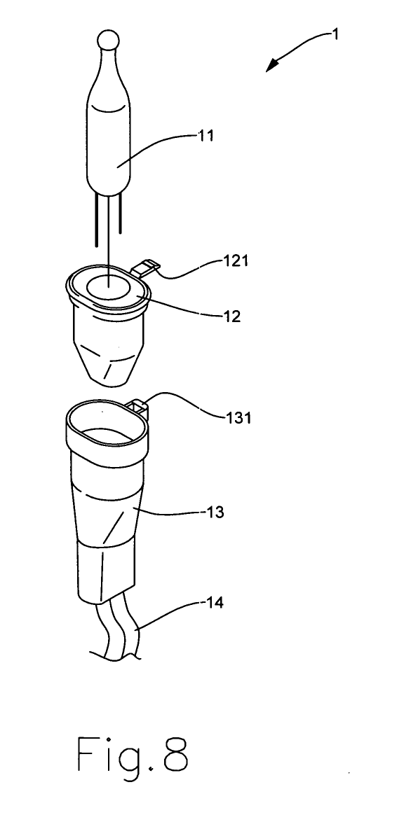

Referring to FIG. 8, a schematic view showing that the present invention is applied to a Christmas lamp with a single bulb. The Christmas lamp 2 is formed by a bulb, a seat 12, and a base 13. A bottom of the Christmas lamp 1 is thereof to a power wire 14. The seat 12 is installed with a buckling plate 121 and the base 13 is installed with a buckling ring 131. The buckling plate 121 is able to be buckled to the buckling ring 131 so as to achieve the connection of the bulb seat 12 with the base 13.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A buckling structure of a Christmas lamp comprising:
a bulb;
a base; one lateral side of the base being extended with a buckling plate; the buckling plate having a bendable concave portion; a distal end of the buckling plate being installed with a hook;
a bulb seat; the bulb being inserted into the bulb seat; one lateral side of the bulb seat having a buckling ring for receiving the buckling plate;
wherein in assembly, when the bulb seat is combined with the base slowly, the hook of the buckling plate is inserted into the buckling ring.

2. The buckling structure of a Christmas lamp as claimed in claim 1, wherein the distal end of the buckling plate has a guide inclined surface.

3. The buckling structure of a Christmas lamp as claimed in claim 1, wherein the concave portion of the buckling plate is at a top of the buckling plate.

4. The buckling structure of a Christmas lamp as claimed in claim 1, wherein the buckling plate is at a lower end of the buckling plate.

5. A buckling structure of a Christmas lamp comprising:
a bulb;
a bulb seat; the bulb being inserted into the bulb seat; one lateral side of the bulb seat being extended with a buckling plate; the buckling plate having a bendable concave portion; a distal end of the buckling plate being installed with a hook;
a base; one lateral side of the base having a buckling ring for receiving the buckling plate;
wherein in assembly, when the bulb seat is combined with the base slowly, the hook of the connecting plate is inserted into the buckling ring.

6. The buckling structure of a Christmas lamp as claimed in claim 1, wherein the distal end of the buckling plate has a guide inclined surface.

7. The buckling structure of a Christmas lamp as claimed in claim 1, wherein the concave portion of the buckling plate is at a top of the buckling plate.

8. The buckling structure of a Christmas lamp as claimed in claim 1, wherein the buckling plate is at a lower end of the buckling plate.
